(19) United States
(12) Patent Application Publication
(10) Pub. No.: US 2002/0065958 A1
(43) Pub. Date: May 30, 2002

(54) System and method for implementing a self-activating embedded application

(76) Inventors: Claude Rocray, Candiac (CA); Giovanni Chiazzese, Pierrefonds (CA)

Correspondence Address: Jones, Day, Reavis and Pogue, North Point, 901 Lakeside Avenue, Cleveland, OH, 44114, US

(21) Appl. No.: 09/921,834

(22) Filed: Aug. 3, 2001

Related U.S. Application Data
(60) Provisional application No. 60/223,080, filed on Aug. 4, 2000.
(60) Provisional application No. 60/223,030, filed on Aug. 4, 2000.

(51) Int. Cl. G06F 9/00

(52) U.S. Cl. 709/331

(57) ABSTRACT

A multiprocessor system is provided that comprises a plurality of processor modules, including a software management processor, a non-volatile storage memory configuration (NVS), and a plurality of software components stored in the NVS, wherein the software components are configured for use with the processor modules. The system further comprises a software generic control information file (SGC) that is also stored in the NVS, wherein the SGC includes information relating to the compatibility of the software components with the processor modules. The software management processor uses the SGC to determine which of the software components to distribute to a processor module that requests software stored on the NVS.

This application claims the benefit under 35 U.S.C. § 119(e) to copending U.S. Provisional Patent Application No. 60/223,080 which is entitled “Self-Activating Embedded Application” and was filed on Aug. 4, 2000. This application also claims the benefit under 35 U.S.C. § 119(e) to copending U.S. Provisional Patent Application No. 60/223,030 which is entitled “Redundant Data Storage Architecture” and was filed on Aug. 4, 2000. This application also incorporates copending U.S. Provisional Patent Application Nos. 60/223,080 and 60/223,030 by reference as if fully rewritten here.

### BACKGROUND

1. Technical Field

The claimed invention relates in general to multiprocessor systems and, more particularly, to a system for loading software in a multiprocessor environment.

2. Description of Related Art

The use of multiple CPUs in a single system is well-known in the field of data processing systems resulting in “multiprocessor” systems. A common need for multiprocessor systems is a method for downloading and/or updating system software and data to be used by the plurality of CPUs in a safe manner that will minimize the chance that the software will be incompatible with the hardware and that will minimize the chance that the system will be harmed by the attempted download.

### SUMMARY

To improve upon the current state of the art, provided is a system and method for dynamically resolving compatibility issues between the different components in the system. The system includes a mechanism that processes the different component production parameters to minimize the chances that the software and hardware devices are not compatible. The system and process makes it more likely that there is compatibility between the components.

The claimed invention may be applicably to most multiprocessor systems that may require that software be updated in the field in a safe manner.

In accordance with one aspect of the invention a multiprocessor system is provided that comprises a plurality of processor modules, including a software management processor, a non- volatile storage memory configuration (NVS), and a plurality of software components stored in the NVS, wherein the software components are configured for use with the processor modules. The system further comprises a software generic control information file (SGC) that is also stored in the NVS, wherein the SGC includes information relating to the compatibility of the software components with the processor modules. The software management processor uses the SGC to determine which of the software components to distribute to a processor module that requests software stored on the NVS.

In accordance with another aspect of the invention a method of operation is provided for use in a multiprocessor system having a plurality of processor modules, a non-volatile storage memory configuration (NVS), a plurality of software components stored in the NVS, wherein the software components are configured for use with the processor modules, and a software generic control information file (SGC) stored in the NVS, wherein the SGC includes information relating to the compatibility of the software components with the processor modules. The a method of operation comprises the steps of checking the SGC to determine if the software components are compatible with the processor modules, requesting software by a first of the processor modules, searching through the SGC to identify which software components are compatible with the first processor module, and supplying a software component file to the first processor module.

### BRIEF DESCRIPTION OF DRAWINGS

The claimed invention will become more apparent from the following description when read in conjunction with the accompanying drawings wherein:

FIG. 1 is a block diagram of an exemplary multiprocessor system that implements one embodiment of the claimed invention;

FIG. 2 is a diagram depicting a file system for use with a preferred embodiment of the claimed invention;

FIG. 3 is a block diagram of an exemplary ring network that implements one embodiment of the claimed invention;

FIG. 4 is a block diagram illustrating exemplary communication between an exemplary system processor and other processors with regard to information in the NVS;

FIG. 5 is a block diagram illustrating the components of an exemplary SGC file; and

FIG. 6 is a flow chart illustrating the boot-up sequence for an exemplary multiprocessor system that incorporates an embodiment of the claimed invention.

### DESCRIPTION OF EXAMPLES OF THE CLAIMED INVENTION

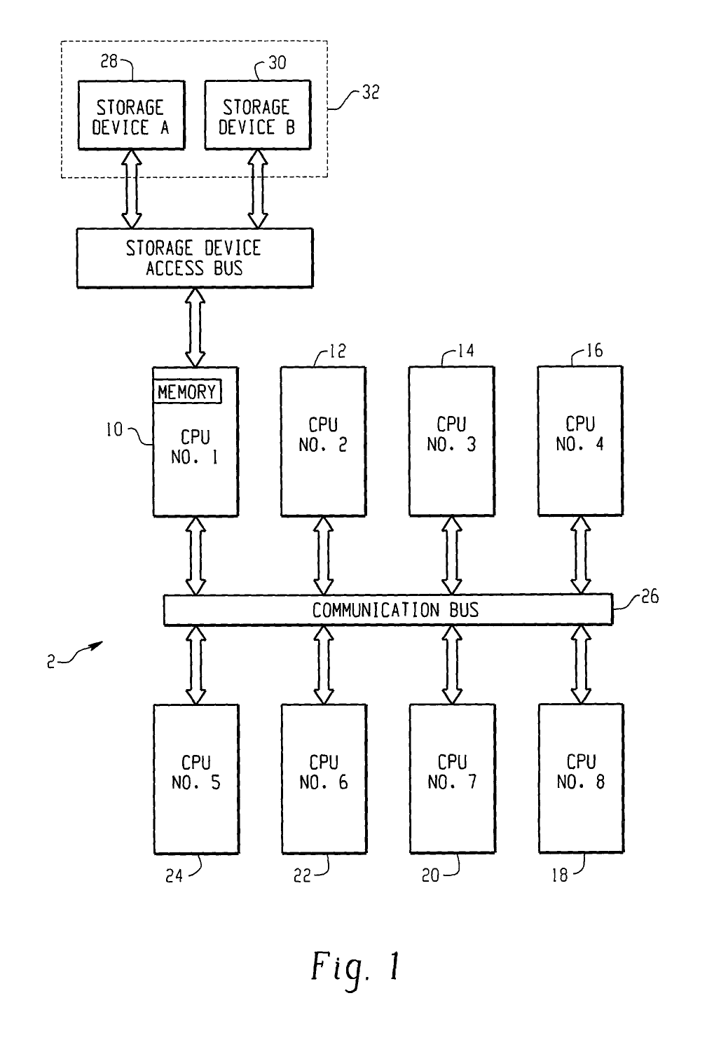

Referring now to the figures, FIG. 1 shows an exemplary multiprocessor system 2 comprising a plurality of processor modules 10-24 that are coupled together via a communication bus 26. Each processor module 10-24 is operable to run application software to perform one or more functions within the system 2. The preferred multiprocessor system 2 also includes two redundant data storage devices-storage device A 28 and storage device B 30, which collectively form a non-volatile storage (NVS) memory configuration 32. One of the primary purposes of the NVS 32 is to store product software for the various processor modules 10-24 wherein product software comprises the various processor application software and data required by the processors 10-24 to perform the system's overall functionality. The NVS 32 provides a centralized storage location for product software especially product software that may need to be upgraded later. Storing the product software in a centralized location in some embodiments makes product updating simpler.

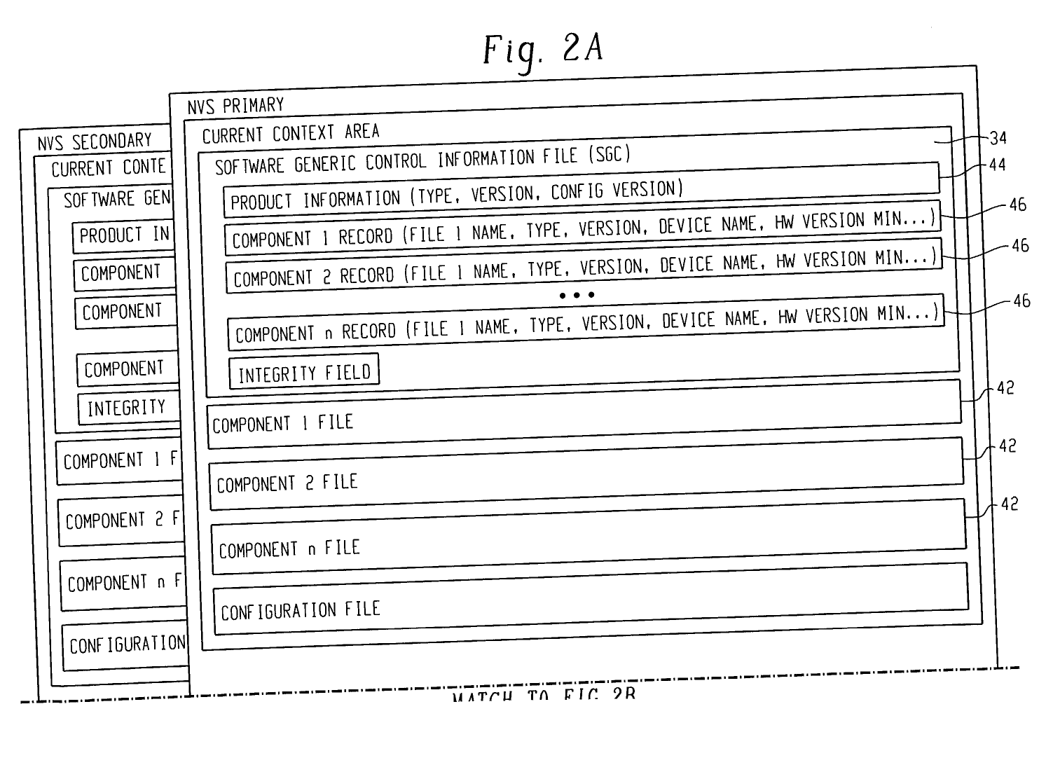

The preferred storage device A 28 and storage device B 30 are non-volatile memory cards containing non-volatile memory devices but optionally could be other devices such as disk drives, CD drives or others. Each storage device 28 and 30 can preferably be removed independently of the other. The NVS 32 preferably is managed as a file system which is referred to herein as Flash File System or FFS. The FFS within each storage device 28 and 30 is duplicated for redundancy purposes as shown in FIG. 2. The redundant data storage devices are described in more detail in the commonly assigned, and co-pending U.S. patent application Ser. No. 09/______ entitled “System and Method For Implementing A Redundant Data Storage Architecture”which was filed simultaneously with this application and is incorporated herein by reference as if fully rewritten herein.

In the preferred system 2, the NVS 32 is only accessible by one processor module, the system processor module 10. The system processor module 10 is responsible for, among other things, transferring software and data stored in the NVS 32 to the other processor modules 12-24, for example, at boot-up or after a software upgrade. The other processor modules 12-24 in the system 2 do not have permanent storage and rely on the system processor module 10 to retrieve their software and data.

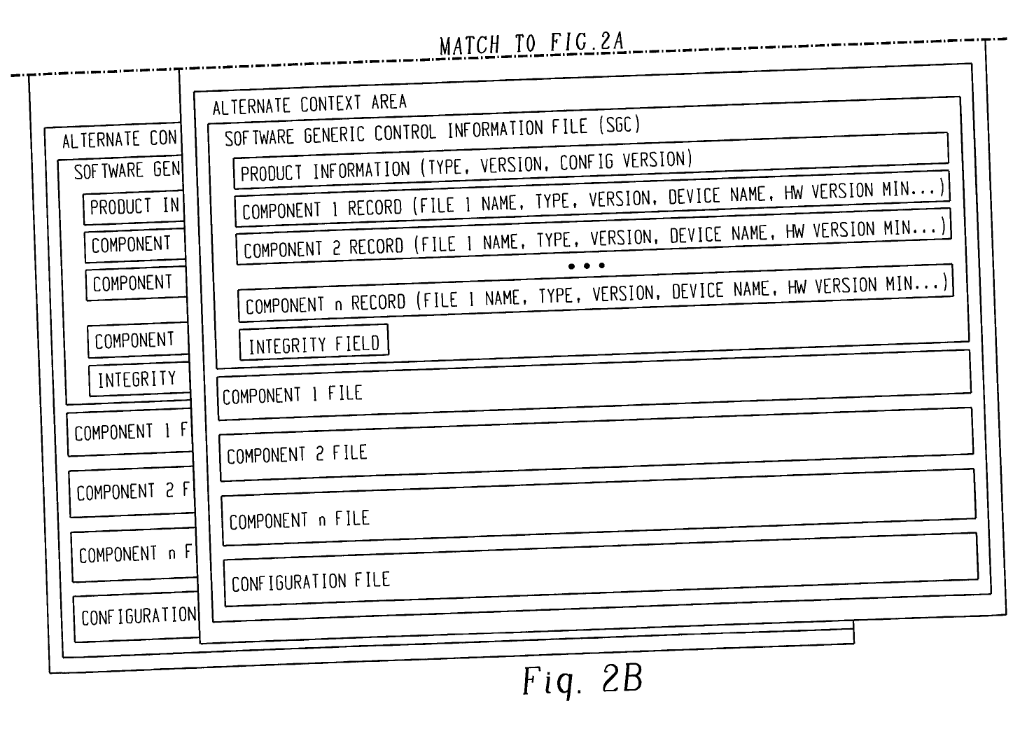

As shown in FIG. 3, the exemplary multiprocessor system 2 preferably is a multiple services carrier node 26 that can be used in networks to transport various types of traffic such as frame-, packet-, and cell-based traffic. The processor modules in this node 26 preferably include traffic carrying modules, such as modules that carry IP or ATM traffic to or from the node, and cross-connect modules, such as modules that pass IP or ATM traffic from one traffic carrying module to another traffic carrying module. An exemplary node element is the MCN 7000. The MCN 7000 is an advanced network element available from Marconi Communications. More details on the MCN 7000 are described in commonly-assigned U.S. patent application Ser. No. 09/875,723 entitled “System And Method For Controlling Network Elements Using Softkeys” which also is incorporated herein by reference.

To dynamically resolve compatibility issues between the different components in the system a software management system (“SM”) is provided for the multiprocessor system 2. The software management system preferably uses a software generic control information file (“SGC”) 34 to maximize the potential that, in a given product, each software component is compatible with the other software components and that the software components are compatible with the hardware within the product. The preferred SGC 34 comprises two portions: a small portion that is the corner stone of the software management validation process (sanity check) and a portion that contains information used to determine which software should be used for the particular hardware and software configuration.

The preferred software management system (“SM”) uses the SGC 34 to load application software and data from the NVS 32 to the processor modules 10-24. When one of the processor modules 10-24 wants to access its software from the NVS, it checks the SGC 34 to determine which component file to request.

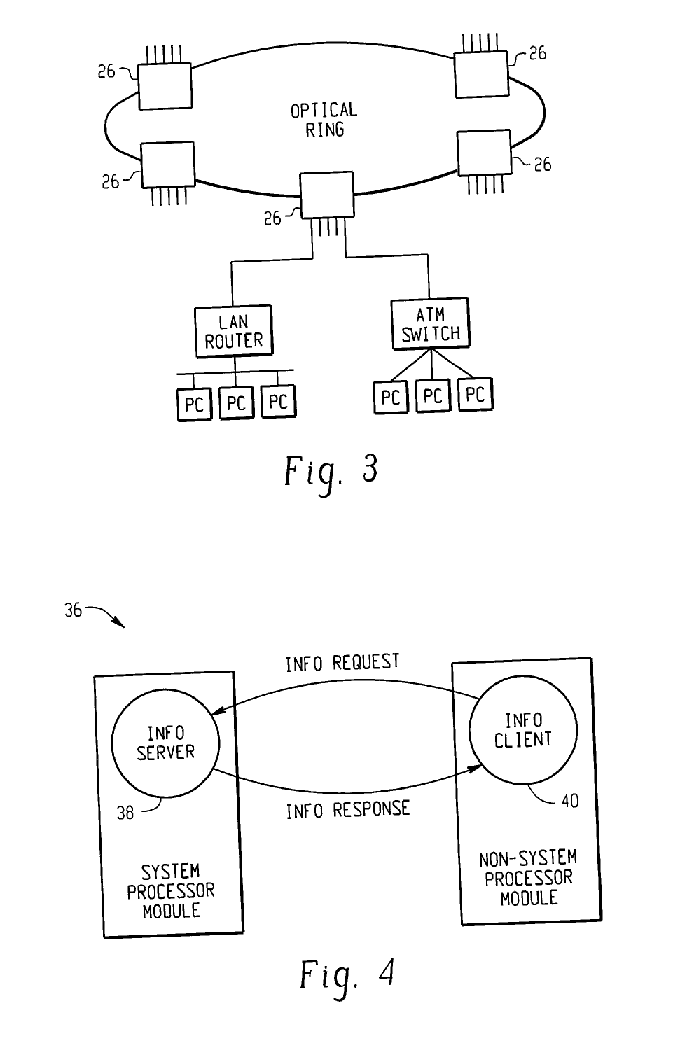

The SGC 34 is directly accessible by the system processor 10 and the SGC information is accessible by the other processors 12-24 preferably using a mailbox system 36. The system processor 10 preferably runs a server process 38 as illustrated in FIG. 4. The other processors 12-24 can submit an information request to the system processor 10 for relevant SGC information and the system processor 10 will return the requested information. Preferably there is one server application 38 on the system processor 10 and a client application 40 running on each of the remaining processors 12-24 that provide the means for passing the SGC information.

For example, when a process on one of the non-system processors 12-24 requires software or data from the NVS 32, the process requests the software from its associated non-system processor. The non-system processor, in response, initiates a request for the software using its mailbox client software 40. The mailbox client software 40 generates a request to the mailbox server 38. The client software 40, for example in one embodiment, provides in the request the “DEVICE_NAME” and optionally a “HW_VERSION” that correspond to the hardware device the requested software relates to. The mailbox server 38 running on the system processor, in response, searches the SGC 34 using the “DEVICE_NAME” and “HW_VERSION” to identify the component 42 in the NVS 32 that corresponds to the request. In a second embodiment, each processor module 10-24 is provided with a software management identification (“SMid”). In this embodiment the client software 40 provides in the request the “DEVICE_NAME” and the SMid. The mailbox server 38 in response searches the SGC 34 using the “DEVICE_NAME” and SMID to identify the component 42 in the NVS 32 that corresponds to the request. In other embodiments, different information may be provided in the request. Once the component 42 is identified, the mailbox server 38 returns a copy of the record (all the information in the file element) of the requested component 42 to the mailbox client 40. The process on the non-system processor module 12-24 that initiated the query can then retrieve the record locally from the non-system processor using a method such as FTP. The process can then decide it should use the received software, for example, to reprogram an FPGA.

Various types of information could be stored in the NVS. Each processor module 10-24 require a number of components 42 to achieve its functionality. Examples of the types of components 42 that could be stored in the NVS and be subject to upgrade include the following: (i) software executables (binary file in compressed format) wherein the software executable could be boot code or application code; (ii) software compiled files (binary file in compressed or non-compressed format); (iii) hardware FPGA (binary file); (iv) software object files (compiled source file in ELF form); (v) software compiled files (binary file in non compressed format); and (vi) data files (ASCII format) as illustrated in Table 1 listed below:

TABLE 1
Card Software Component Requirement

| | | Required |
|---|---|---|
| Component Type | Component Function | number |
| Software executable | Boot code | 1 |
| Software executable | Application code | 1 to n |
| ASCII Data file | Product/Module parameterization (in | 0 to n |
| | the form of “Keyword = value” . . .) | |
| Software compiled | Initialized data structure | 0 to n |
| files | | |
| Software object files | VxWorks dynamically loadable | 0 to n |
| | modules | |
| Hardware FPGA | Hardware component functionality | 0 to n |

Software Generic Control Information File (SGC)-First Embodiment

The software management system (“SM”) relies on the SGC 34 to manage the distribution of software inside the multiprocessor system. The SGC 34 ties together all of the components 42 of a product release. The SGC 34 includes information that identifies which software versions correspond to which hardware versions. The SGC 34 provides the information necessary for determining which components 42 are to be used at start up and during execution. The SGC 34 has a formatted ASCII content with preferably two type of information: the product level information 44 and the component level information 46 as illustrated in FIGS. 2 & 5.

The product level information 44 of a first embodiment of an exemplary SGC 34 is illustrated in table 2 shown below:

TABLE 2
SGC: Product Level Information

| Info | Values |
|---|---|
| Product Type | String. |
| Release Version | Formatted string using numbers separated by dots. |
| Release type | Production, beta |
| Configuration | Integer |
| Version | |
| System Loader | String (file name) |

The product type identifies the different type of hardware modules 10-24 supported by the component files 42 within the software release and their level of functionality. The release version identifies the version of the software release and has user level visibility. Whenever there is a component 42 change in the product release, the release version changes. Therefore, the release version defines a precise set of components 42. The Product Release type defines the type of release the SGC 34 contains. The release preferably is either an official “Production” release or a “Beta” release.

The configuration version identifies the format of the data in the configuration file 42. The configuration file data is preferably stored in a table format. The table format, however, may change over time. Changes in the table format may affect some software components 42 while being transparent to other. Each component 42 preferably includes an internal indication of its minimum configuration version. The affected components 42 preferably would have their internal indication of minimum configuration version updated to reflect their incompatibility with the table format identified by the new configuration. The internal configuration value can be compared with the product level configuration version. The internal value must be smaller or equal to the product one.

The system loader preferably defines through a file name a software executable able to interpret the SGC 34. The format of the SGC 34 may evolve with time. The system loader provides a mechanism for allowing the system to adapt to changes in the SGC 34 format. The system loader preferable will run in either the boot or application environment. The system loader information is therefore recognizable by the boot and the application code whereas the remaining SGC information may not be recognizable. Boot or application code, after a software download, preferably reads the file name identified by the system loader, loads the software executable application identified and the executable application can then take over and proceed with the software retrieval.

Each component level record 46 in the SGC 34 corresponds to a specific component file 42. The preferred component level information contained in the SGC 34 is illustrated in table 3 shown below:

TABLE 3
SGC: Component Level Information

| Info | Values |
|---|---|
| File name | Any valid Win95 or Win NT file name. |
| Type | Boot code, loadable application, initialized data structure, |
| | loadable modules (add-on), and hardware components. |
| Storage type | Compressed, non-compressed . . . |
| Version | Formatted String (format to define) |
| Device name | String |
| HW Version | Integer |
| Min | |
| HW Version | Integer |
| Max | |
| Execution | Board types |
| environment | |
| Size | Integer |
| Checksum | Integer |

The file name field contains the file name to be used to retrieve the component 42. Preferably long file name such as those used in Windows 95 and Windows NT are supported.

The type field identifies the type of the component 42. The types include boot code, loadable applications, initialized data structures, loadable modules (add-on), and hardware components as illustrated in table 1 and discussed above.

The storage type identifies the manner in which the component 42 was stored such as whether the component 42 was stored is a compressed format or a non-compressed format.

The version field defines the version of the component 42. This information must match any version information embedded within the component 42.

The component device name provides the SGC 34 with a mechanism to indirectly relate the different hardware and software components in a system to each. This mechanism is referred to herein as an indirection mechanism. The indirection mechanism provides flexibility for component file naming and allows for the modification of hardware components, when this is required, with traceability (different file name) and without having to modify the software component 42.

With the indirection mechanism, a processor module requests its software components 42 by providing a device name instead of a file name. This allows multiple hardware component versions that belong to the same processor module type (and software executable) to co-exist in the same product release. As a result, multiple component records related to the device name would exist within the release, but the HW minimum and maximum versions information can be used to isolate the correct component 42 to use with a specific device. The indirection mechanism allows a software release to include different versions of a software component wherein each version handles a different hardware version.

The hardware version min. and max. fields identify the hardware version range supported by the component 42. Each time hardware on a processor module 12-24 is modified, the components 42 that support that processor module are preferably validated against the new hardware version. After successful testing with a component 42, the hardware version max field associated with that component can be updated to reflect the new hardware card version.

The execution environment field identifies where the associated component 42 is to be executed, i.e., with which processor module. If the associated component 42 is modified, for example, as a result of a software update, the software management system uses the execution environment field information to identify which processor module needs to be re-initialized so that the processor module will request the modified component 42. Preferably, there is a one-to-one relationship between a component 42 and a processor module type. For cases where a component 42 were related to more than one processor module type, then the component 42 would preferably be considered by the software management system as being related to all processor module types and the execution environment field would so indicate. If such a component 42 were modified through a partial product software upgrade, the whole system would re-initialize as it would with a complete product software upgrade.

The size and checksum fields are used for error detection. After a component has been downloaded in the system, the size and checksum fields can be used to verify that the component is the correct component and that it was completely downloaded and not corrupted. The probability of having two files with the same name, size and checksum but being different is almost non-existent (more or less dictated by the checksum error coverage).

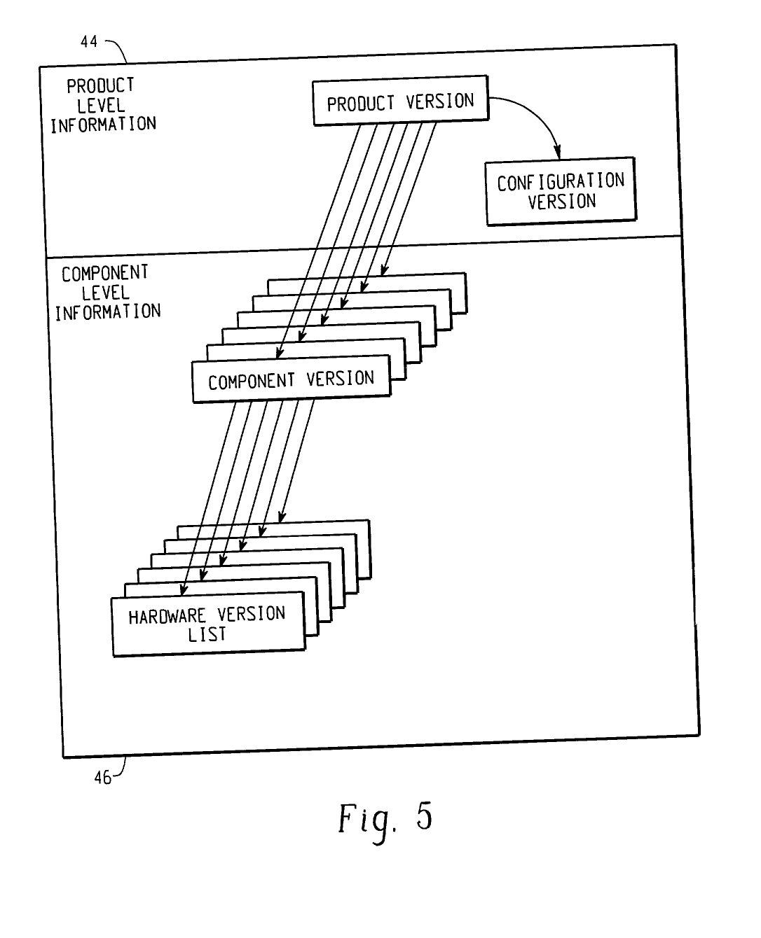

FIG. 5 illustrates the relationship between the different version information contained in the SGC 34. The product and component versions preferably are a formatted string while the hardware and configuration versions preferably are a single number value.

Second Embodiment of SGC file

The SGC file is preferably an ASCII file where each line entry describes a specific SM parameter. A line entry preferably has the form A=B, where A is the parameter mnemonic and B its associated value. In general, related parameter entries are grouped together in sections that start with a title between brackets ([ . . . ]).

Example:

[any section title]

parameter1=value1

parameter2=value2,value3,value4

In general in the second embodiment of the SGC: parameters that are related together are normally grouped in a section; a section starts with a title and ends with the title of the next section; parameter values can be interpreted as integers, enumeration values or strings; integer values are always expressed in decimal notation; parameters can have a list of values (as in parameter2); lines starting with a semi-column are not processed; blank lines are not processed; order of parameters inside a section is not relevant; and section order is not relevant.

In the second embodiment, the process of selecting a component 42 used to program a device on a processor module is made independently for each device, without any reference to the other devices on the same processor module.

Since components 42 used to program devices are revised from time to time, for each device, a set of candidate components 42 (i.e. different versions) might exist that could be used to program a processor module device. The SM preferably selects the most recent version. This selection is done independently for each device on the processor module. The selected components 42 thus are not bundled together.

Alternatively, the components 42 can be bundled together into sets called sub-packages. A sub-package is used to program all the devices on a processor module, and for each processor module only one version of a component 42 is part of the sub-package. Sub-packaging can be used to allow a more convenient way of selecting components 42 for devices, and to limit the combinations of components 42 that could go on a version of a processor module. Thus, only some combinations of components 42, i.e. the sub-packages, are allowed to be loaded on a processor module.

The SGC file 34 in the second embodiment preferably contains seven different types of sections: Product, Card type, Card revision, Code and vector, Boot code, Application load, and Device sections.

Product section

There is preferably a product section normally located at the beginning of the SGC file 34. It is used to provide general information on the software package. The typical type of information contained in the product section is shown below.

| Parameter | Type |
|---|---|
| [Product] | Header |
| ProductType = Integration | Enumeration |
| ReleaseType = Engineering | Enumeration |
| ReleaseVersion = 84.1.5.7 | Swing |
| ConfigVersion = 1 | Integer |

The ReleaseVersion parameter has a string value that is used to identify the package version. In the above example, the package version is 84.1.5.7.

Card type section

There is preferably a card type section normally located right after the product section. Its purpose is to define the processor modules that are supported in the system.

| Parameter | Type |
|---|---|
| [CardType] | Header |
| SuppTypes = NMCU,DS3,DS3EC1, | String list |
| QOC12,OC48,XCON,XCN2,OC192, | |
| XC60,DS1E1,VTXCON,XC40,FASTE | |
| SMIdList = 1,4,5,6,7,8,11,12,13,14,15, | Integer list |
| 18,19 | |

There are two parameters in this sections: the SuppTypes parameter and the SmidList parameter. Each parameter contains a list of values that are used to associate processor module names and SM ids together. String and integer values that have the same position in the lists are related. For example, 6 and QOC12 are related.

Card revision section

The Card Revision section describes the programmable devices on a multiprocessor module and the preferred device sub-package for a specific revision of that module. There is one Card Revision section per supported processor module revision.

| Parameter | Type |
|---|---|
| [Card Revision] | Header |
| CardSMId = 14 | Integer |
| Revision = 0 | Integer |
| Devices = SYNCFPGA,MAPPERFPGA | String list |
| Identifiers = 1,0 | Integer list |
| SubPackages = 1 | Integer |
| HWIds = 0 | Integer |

In the above example, a module having SM id 14 (DS1E1) and SM rev 0 has two devices, SYNCFPGA and MAPPERFPGA. SYNCFPGA has an identifier of 1 while MAPPERFPGA has an identifier of 0 (programmable devices are physically daisy-chained and the identifier is the hardware index). The SubPackages parameter indicates that the device sub-package rev 1 is the “preferred” sub-package to use. The HWIds parameter is not used and must be set to 0.

Code and Vector section

The code and vector sections describe the files used to upgrade the application code and vector table of a given multiprocessor module. There is one code and vector sections per supported processor module.

| Parameter | Type |
|---|---|
| [DS3PSCU code] | Header |
| Name = DS3PSCU | String |
| File = PSCU3C90.z | String |
| Compressed = YES | Enumeration |
| Version = 9.0 | String |
| Size = 1737 | Integer |
| Checksum = 2314674762 | Integer |
| SMid = 3 | Integer |
| [DS3PSCU vector] | Header |
| Name = DS3PSCU | String |
| File = PSCU3V90.z | String |
| Compressed = YES | Enumeration |
| Version = 9.0 | String |
| Size = 54 | Integer |
| Checksum = 3665842800 | Integer |
| SMid = 3 | Integer |

In the above example, the code and vector sections describe the code and vector version 9.0 for the DS3PSCU multiprocessor module.

Boot code section

The boot code section describes the file used to upgrade the boot code of a given processor module. There is one Bootcode section per supported module type.

| Parameter | Type |
|---|---|
| [DS1E1 Bootcode] | Header |
| Name = DS1E1 | String |
| File = B860198.z | String |
| Compressed = YES | Enumeration |
| Version = 1.9.8 | String |
| Size = 175545 | Integer |
| Checksum = 547444505 | Integer |

In the above example, the Bootcode section describes the boot code 860 version 1.9.8 for the DS1E1 card.

Application load section

The Loadapp section describes the application load and the compatible device sub-packages. There is one Loadapp section per supported processor module type.

| Parameter | Type |
|---|---|
| [DS1E1 Loadapp] | Header |
| Name = DS1E1 | String |
| File = DS1LOAD.Z | String |
| Compressed = YES | Enumeration |
| Version = 1.0 | String |
| Size = 685638 | Integer |
| Checksum = 2357736701 | Integer |
| CompSubPkgs = 1 | Integer list |
| CardRevisions = 0 | Integer |

In the above example, the Loadapp section describes the application load file to use for a DS1E1 card. This application load supports the device sub-package rev 1.

Device section

The Device section describes a file in the package that can be used to program a given device on a processor module. There is at least one Device section per programmable device. There can be several Device sections per programmable device if there are several sub-packages to support different processor module revisions. There is only one application load per module type, but there can be several sub-packages for that processor module. The CompSubPkgs parameter in the Loadapp section defines which ones of those sub-packages are supported. In general, all the sub-packages and application load found in a given package are compatible with each other.

| Parameter | Type |
|---|---|
| [DS1E1 Device] | Header |
| Name = SYNCFPGA | String |
| File = SYNCF037.z | String |
| Compressed = YES | Enumeration |
| Version = 37 | Integer |
| Size = 41427 | Integer |
| Checksum = 3245628327 | Integer |
| MbrOfSubPkgs = 1 | Integer list |
| HWType = 2 | Integer |

The above Device section describes SYNCFPGA rev 37 for the DS1E1 card. The associated file in the package is syncf037.z. This device is a member of sub-package rev 1, and HWType=2 means that it is an FPGA device. Any single device file like this one can be the member of multiple sub-packages. This is why the MbrOfSubPkgs parameter (Member of Sub-Packages) is a list. The header refers to a card type while the Name parameter identifies a specific programmable device.

Exemplary System Configuration

In the preferred multiprocessor system 2, the compatibility between the hardware and software is managed primarily via the SGC 34. When a new product release is developed, the software components 42 preferably have been verified to ensure that there are no compatibility problems with other software components 42 and with the various versions of hardware in the system. Once the product release has been verified, the SGC 34 is used by the system 2 to ensure that the correct components 42 are used with the appropriate microprocessor modules 10-24 so that compatibility issues are minimized.

The activation of a new product release can be initiated in a number of ways. First, after the new software has been loaded, the system can be powered down and re-booted using the portion of the NVS that contains the new software load. Alternatively, the activation of a new software load can be initiated while the system is operational. In this case, the system processor is commanded to perform a software reboot. Methods for loading a new product release into the NVS 32 are described in more detail in commonly assigned U.S. patent application Ser. No. 09/______. Alternatively, if a processor module is added to the system, the system will activate the new processor module by providing the processor module with its software.

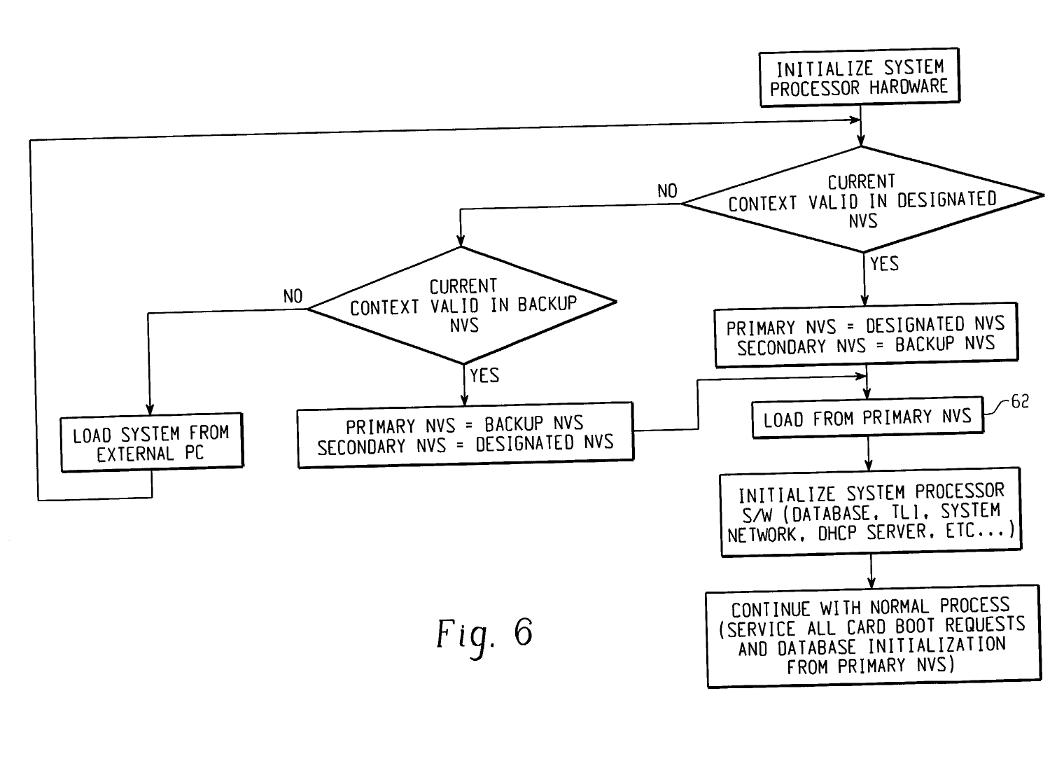

An exemplary activation of a new software load will be described next. After a new product release has been loaded onto the NVS 32 and the system is powered on, the system processor 10 coordinates the system boot up. The system processor 10 accesses the NVS 32 and loads the primary NVS into local memory. The system processor 10 and system boot up is outlined in FIG. 6. The system processor 10 then initializes and is ready to respond to requests from other processor modules 12-24.

The other processor modules 12-24 also power on and then request their software executables from the system processor preferably using the client server model described above. The software executable may require other components 42 to operate. In one embodiment, each software executable preferably is designed such that it has knowledge of the other components 42 it requires for operation. Alternatively, the software executables could acquire this knowledge from the server. The SGC 34 is used to retrieve the other components 42 preferably by using the device name indirection mechanism.

After loading its software executables, the processor modules 12-24 preferably may then request their hardware device binary configuration files. This is preferably accomplished through the use of the device name indirection mechanism. The device name is converted to the proper file name by the system processor 10 using the SGC 34 so that the component file designed for use with the specific processor module hardware version is chosen. The processor module retrieves its component file and implements it.

In an alternative mode of operation, the multiprocessor system 2 has the ability to continue running on its current version of software and while it is running, the system has the capability of allowing a download of some other version of software, be it an upgrade or a downgrade into the backup bank of the NVS, and then at some point when both versions are residing on the NVS at the same time, an instruction can be given for the system processor 10 or the whole system to switch and use the software on the alternate bank. To accomplish this, an instruction is provided to the system processor 10 to make the change. In present systems, the alternate bank typically must be written into to instruct the system that the alternate bank should be treated as the active bank at the next boot up. In the preferred system, the system processor can be instructed, for instance by a special tag in the system processor memory, to boot up from the alternate bank the next time it boots up. Preferably, the tag in memory instructs the system processor to perform the alternate boot up one time only. When the system processor performs this special boot up, for example as the result of a software upgrade, the system processor first boots up using the new software and then checks the SGC file 34, the execution environment field in particular, and enables the processor modules affected by the update to initialize themselves and boot-up. While the system processor is booting up it clears that tag immediately so that it will not reboot twice in a row from that bank if a fault or error exists.

After the system has booted from the alternate bank, the system processor 10 will finally, as one of the very last stages, recognize that it booted from the alternate bank and realize that the alternate bank it just booted from is not currently activated. The system preferably performs self checks and after the system determines that it has successfully booted from the alternate bank and is running in a healthy manner, the system processor will then activate the alternate bank. This provides a protection mechanism whereby if any problems or error occur anywhere from the time of the download, to the time at which the instruction to swap was given, to the rebooting, and to the reading of the data, the system would naturally reboot back on the original current bank and abort the process of booting from the alternate bank without putting the system out of commission. Consequently, the system will not continue to reboot from a bank unless it has been proven that the bank can be successfully booted from.

The embodiments described above are examples of structure, systems or methods having elements corresponding to the elements of the invention recited in the claims. This written description may enable those skilled in the art to make and use embodiments having alternative elements that likewise correspond to the elements of the invention recited in the claims. The intended scope of the invention may thus include other structures, systems or methods that do not differ from the literal language of the claims, and may further include other structures, systems or methods with insubstantial differences from the literal language of the claims.

1. A multiprocessor system, comprising:
a plurality of processor modules, including a software management processor;
a non-volatile storage memory configuration (NVS);
a plurality of software components stored in the NVS, wherein the software components are configured for use with the processor modules; and
a software generic control information file (SGC) stored in the NVS, wherein the SGC includes information relating to the compatibility of the software components with the processor modules; and
wherein the software management processor uses the SGC to determine which of the software components to distribute to one of the processor modules that requests software stored on the NVS.

2. The system of claim 1 wherein the NVS comprises disk space.

3. The system of claim 1 wherein the NVS comprises memory devices.

4. The system of claim 1 wherein the NVS comprises CDs.

5. The system of claim 1 wherein the SGC contains a product section and a component section.

6. In a multiprocessor system having a plurality of processor modules, a non-volatile storage memory configuration (NVS), a plurality of software components stored in the NVS, wherein the software components are configured for use with the processor modules, and a software generic control information file (SGC) stored in the NVS, wherein the SGC includes information relating to the compatibility of the software components with the processor modules, a method of operation comprising the steps of:
checking the SGC to determine if the software components are compatible with the processor modules;
requesting software by a first of the processor modules;
searching through the SGC to identify which software components are compatible with the first processor module;
supplying a software component file to the first processor module.

7. The method of claim 6 wherein the searching step further comprises the step of searching by maximum and minimum hardware type.

8. In a multiprocessor system having a plurality of processor modules, a non-volatile storage memory configuration (NVS) having a primary bank and an alternate bank, a plurality of software components stored in the NVS, wherein the software components are configured for use with the processor modules, and a software generic control information file (SGC) stored in the NVS, wherein the SGC includes information relating to the compatibility of the software components with the processor modules, a method of activating a software load comprising the steps of:
downloading the software load to the alternate bank;
initiating a system boot up using software component stored in the alternate bank;
checking the SGC to determine which software components are compatible with which processor modules;
providing to the processor modules the software components that they are compatible with;
verifying that the system is operating properly
re-designating the former alternate bank as the new primary bank and the former primary bank as the new alternate bank

9. The method of claim 8 wherein the NVS comprises two redundant storage devices.

10. The method of claim 9 wherein the two redundant storage devices are non-volatile memory cards containing non-volatile memory devices.

11. The method of claim 8 wherein the multiprocessor system further comprises a software management processor wherein the software management processor is the only one of the processors that has direct communication with the NVS.

12. The method of claim 8 wherein the NVS comprises two redundant storage devices.

13. The method of claim 12 wherein each redundant storage device has a file system comprising:
a current context area containing a copy of system software that is accessible for uploading to the software management processor; and
an alternate context area that is accessible to the system processor for downloading a different version of system software.

14. A multiprocessor system, comprising:
a plurality of processor modules;
a non-volatile storage memory configuration (NVS);
a plurality of software components stored in the NVS, wherein the software components are configured for use with the processor modules; and
a software generic control information file (SGC) stored in the NVS, wherein the SGC includes information relating to the compatibility of the software components with the processor modules; and
wherein a first of the processor modules requests software that is stored on the NVS and wherein the SGC is used to determine which of the software components is to be provided to the first processor in response to the request for software.

15. The system of claim 14 wherein the NVS comprises two redundant storage devices.

16. The system of claim 15 wherein each redundant storage device has a file system comprising:
a current context area containing a copy of system software that is accessible for uploading to the software management processor; and
an alternate context area that is accessible to the system processor for downloading a different version of system software.

17. The multiprocessor system of claim 16 wherein the alternate context area and current context area in each redundant storage device may be switched, whereby system software in the alternate context area becomes accessible to the software management processor for uploading.
